(19) United States
(12) Patent Application Publication
(10) Pub. No.: US 2009/0059378 A1
(43) Pub. Date: Mar. 5, 2009

(54) Devices, Systems, and/or Methods for Providing Illumination

(76) Inventors: Brian Thompson, Deering, NH (US); Michael C. Messina, Hooksett, NH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/204,461

(22) Filed: Sep. 4, 2008

Related U.S. Application Data
(60) Provisional application No. 60/970,064, filed on Sep. 5, 2007.

(51) Int. Cl. G02B 5/02

(52) U.S. Cl. 359/599

(57) ABSTRACT

Certain exemplary embodiments can provide and/or utilize a system comprising a first sheet formed of a light-diffusing material, said first sheet defining a pair of opposing faces and two pairs of opposing edges, said first sheet adapted to provide a substantially uniform illumination from at least one of said faces when light is transmitted into any of said edges; a first reflective layer adapted to reflect light toward a second face of said pair of faces; a second sheet formed of a light diffusing material; and a first light source adapted to transmit light into a first edge of said edges.

### CROSS-REFERENCES TO RELATED APPLICATIONS

This application claims priority to, and incorporates by reference herein in its entirety, pending U.S. Provisional Patent Application Ser. No. 60/970,064 (Attorney Docket 2007P19183US), filed 5 Sep. 2007.

### BACKGROUND

Objects can be illuminated for camera imaging and/or Machine Vision applications via a light source. The light energy from the light source can be diffused by a light transmitting diffuser material. The objects can be illuminated by the diffuse light such as from behind. Improved devices, systems, and/or methods for providing illumination can be desirable for certain applications.

### SUMMARY

Certain exemplary embodiments can provide and/or utilize a system comprising a first sheet formed of a light-diffusing material, said first sheet defining a pair of opposing faces and two pairs of opposing edges, said first sheet adapted to provide a substantially uniform illumination from at least one of said faces when light is transmitted into any of said edges; a first reflective layer adapted to reflect light toward a second face of said pair of faces; a second sheet formed of a light diffusing material; and a first light source adapted to transmit light into a first edge of said edges.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a front view of an exemplary embodiment of a system 1000;

FIG. 2 is a cross-sectional view taken at section A-A of FIG. 1;

FIG. 3 is a portion of the cross-sectional view taken at section A-A of FIG. 1;

FIG. 4 is a portion of a cross-sectional view of an alternative embodiment taken at section A-A of FIG. 1;

FIG. 5 is a portion of a cross-sectional view of an alternative embodiment taken at section A-A of FIG. 1;

FIG. 6 is a portion of a cross-sectional view of an alternative embodiment taken at section A-A of FIG. 1;

FIG. 7 is a portion of a cross-sectional view of an alternative embodiment taken at section A-A of FIG. 1;

FIG. 8 is a flowchart of an exemplary embodiment of a method 8000;

FIG. 9 is a block diagram of an exemplary embodiment of a system 9000; and

FIG. 10 is a block diagram of an exemplary embodiment of an information device.

### DETAILED DESCRIPTION

Camera-based inspections often require lighting to be optimized for a given application. Optimized lighting for an application can become difficult when parts vary in geometry and/or finish.

Direct Part Marking (DPM) is a technology whereby an item is physically altered by methods such as dot peening, laser etching, molding, and/or embossing to produce two different surface conditions.

Marking can result in the symbol being created by either smooth and rough (or dull and shiny) areas on the substrate or a symbol comprised “dots” below or above the substrate surface. DPM is typically used with matrix symbologies, such as bar codes and/or data matrices.

There is often very little or no contrast between the “marked” elements of a symbol and the background (substrate). There is often very little or no contrast between edges of an object and the background. Contrast can be achieved by using specific types of lighting and/or signal processing techniques.

Complex vision applications can be adapted to inspect certain features of one or more parts. Certain exemplary embodiments can be mounted in proximity to a camera lens of a Vision Inspection System, and/or can emit light onto a part and/or component being inspected, such as via frontlighting, sidelighting, and/or backlighting.

Certain exemplary embodiments can provide and/or utilize a system, such as an illumination system, comprising a first sheet formed of a light-diffusing material, said first sheet defining a pair of opposing faces and two pairs of opposing edges, said first sheet adapted to provide a substantially uniform illumination from at least one of said faces when light is transmitted into any of said edges; a first reflective layer adapted to reflect light toward a second face of said pair of faces; a second sheet formed of a light diffusing material; and a first light source adapted to transmit light into a first edge of said edges.

Certain exemplary embodiments can be used to create a substantially uniform illumination system and/or backlighting system for machine vision applications. ENDLIGHTEN material can redirect the light entering its edges and/or uniformly distributes that light over its surface and/or a diffuser can enhance the uniformity of the light output from that surface of the ENDLIGHTEN material in any of three ways:
by simple diffusion of the light output;
by protecting the ENDLIGHTEN from scratches, which can appear much brighter than the surrounding surface; and/or
by masking the ENDLIGHTEN materials' bright illumination of foreign particles (e.g., dust) located directly on the surface of the ENDLIGHTEN material by diffusing the light output and/or acting as a dust shield.

The reflective surface beneath the ENDLIGHTEN material can redirect wasted light emitted from the bottom of the ENDLIGHTEN material back towards the desired output surface through the ENDLIGHTEN material and the diffuser to increase light output. The level of reflectivity of the reflective surface can affect the intensity of the light output.

It can be appreciated that the light output of certain exemplary embodiments can be enhanced by placing reflective material along any and/or all of the surfaces of the ENDLIGHTEN material other than the illuminated area and the areas where light enters the ENDLIGHTEN material from the light sources. The reflective material can redirect what would be wasted light back into the ENDLIGHTEN material.

In certain exemplary embodiments, the light output of this technique can be enhanced by polishing the surface where light enters the ENDLIGHTEN material from the light sources.

In an exemplary embodiment, a direct illumination unit, can have an illuminated area 100 mm×100 mm and/or can require 144 LED light sources to provide adequate uniformity. In another exemplary embodiment, the side lighting system and method described above can provide an illuminated area of 100 mm×200 mm and/or can require only 8 LED light sources to provide adequate uniformity.

Certain exemplary embodiments can use LEDs with built-in side emitting optics to eliminate any need for a secondary optic to redirect the light exiting the top of the LED to the sides of the LED. This can reduce the number of components in the assembly and/or simplify assembly.

In certain exemplary embodiments, designing a gap between the reflective surface beneath the ENDLIGHTEN material and the bottom of the ENDLIGHTEN Material can prevent the two surfaces from contacting and/or the non-uniformities in light output that can result from such contact.

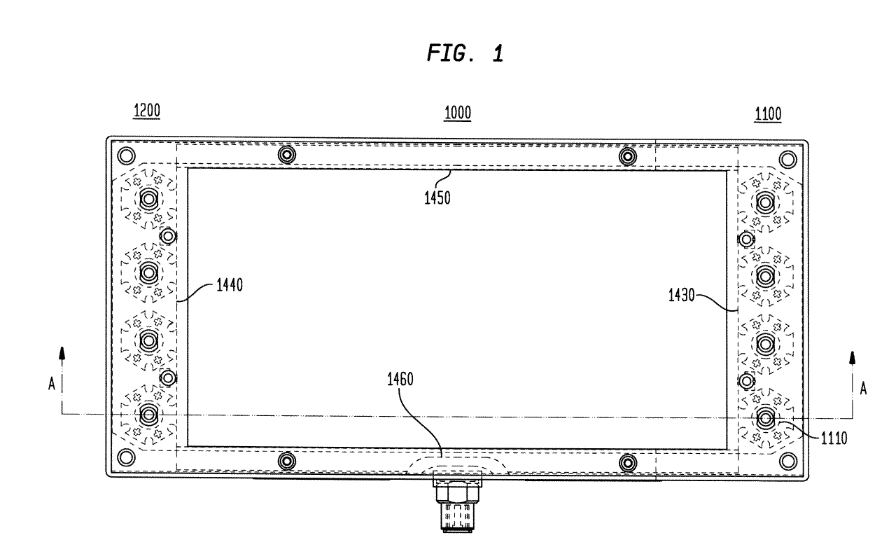

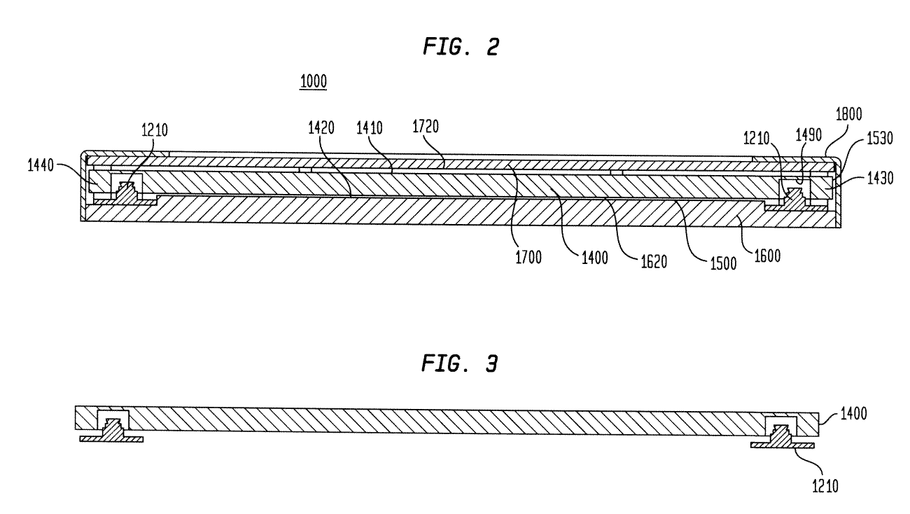

Referring to FIGS. 1 and 2, system 1000 can comprise a first light source 1100 and a second light source 1200, each of which is shown as an array of LED's, but either or both of which can be any type of light 1110, 1210, such as an incandescent light, halogen light, florescent light, neon light, fiber optically transmitted light from a remotely located source, and/or electro-luminescent panel, etc. Power conduit 1300 can convey electrical power, control signals, and/or sensor signals to and/or from light sources 1100, 1200 and/or system 1100.

A substantially planar sheet 1400 can be formed of a substantially transparent, unfaceted, ungrooved, light-diffusing polymeric material, such as ENLIGHTEN. Sheet 1400 can define a pair of opposing substantially planar faces 1410, 1420 and two pairs of opposing substantially planar edges 1430, 1440 and 1450, 1460. Each of edges 1430, 1440, 1450, 1460 can be oriented substantially perpendicular to each of faces 1410, 1420. Sheet 1400 can be adapted to provide a substantially uniform illumination from face 1410 when light is transmitted into any of edges 1430, 1440, 1450, 1460.

A cavity, well, hole, and/or bore 1490 in sheet 1400 can at least partially surround at least one light 1110 of light source 1100. Light source 1100 can be located substantially adjacent to, and/or can be adapted to transmit light into, edge 1430.

A substantially planar base 1600 can be located substantially parallel to sheet 1400 and/or face 1420. At least one light 1110 of light source 1100 can be attached to base 1600, which can comprise and/or serve as a heat sink, such as a substantially planar aluminum plate, for light source 1100, 1200. Sheet 1400 can be separated from base 1600 by a predetermined gap 1620, to avoid contact therebetween, which might cause discontinuities and/or non-uniformities in any light emitted by sheet 1400.

Located between base 1600 and sheet 1400 and/or substantially parallel to face 1420 can be a substantially planar material and/or layer 1500 that is substantially reflective and/or adapted to reflect at least a portion of the light emitted from sheet 1400 in the general direction of base 1600 back into sheet 1400. Layer 1500 can be integral to, attached to, or separated from base 1600. Located between base 1600 and sheet 1400 and/or substantially parallel to any edge 1430, 1440, 1450, 1460 can be a corresponding substantially planar material and/or layer, such as layer 1530, that is substantially reflective and/or adapted to reflect at least a portion of the light emitted from or toward the corresponding edge, such as edge 1430, of sheet 1400 in the general direction of layer 1530 back into sheet 1400. Any of these layers, such as layer 1530, can be integral to, attached to, or separated from base 1600. To prevent discontinuities and/or non-uniformities, any of any edges 1430, 1440, 1450, 1460 can be polished or otherwise smoothed.

Located substantially parallel to face 1410 can be a substantially planar diffuser sheet 1700 formed of a substantially light diffusing material. Sheet 1700 can be separated from face 1410 and/or sheet 1400 by a predetermined gap 1720, to avoid contact therebetween, which might cause discontinuities and/or non-uniformities in any light emitted by sheet 1400 and/or system 1000.

Located substantially parallel to and/or substantially adjacent to face 1410 and/or diffuser sheet 1700 can be a substantially planar cover 1800 formed of a substantially opaque material, which can be adapted to block undesired light from the light sources outside of the intended uniform area of illumination. Cover 1800 can contain the system wiring and/or prevent foreign objects from damaging internal components such as diffuser sheet 1700, sheet 1400, and/or light source 1110. Cover 1800 can protect outer edges and/or sides of such components, but can be open over the illuminated area, thereby not necessarily protecting the visible illuminated area and/or the full face of diffuser sheet 1700 and/or sheet 1400.

A camera and/or machine vision system can be adapted to capture and/or interpret an image of an object, component, document, label, etc., which can be illuminated by light sources 1100, 1200 and/or system 1000.

FIG. 3 is a portion of the cross-sectional view taken at section A-A of FIG. 1, showing a side-emitting LED 1210 partially embedded in acrylic sheet 1400.

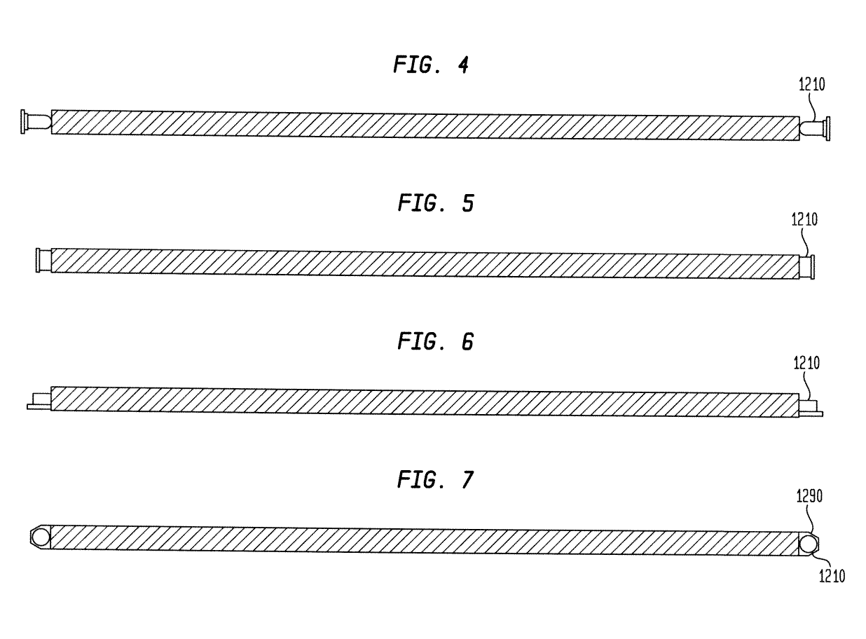

FIG. 4 is a portion of a cross-sectional view of an alternative embodiment taken at section A-A of FIG. 1, showing a top-emitting, lead-mounted, and circuit-board-attached LED 1210 aimed into opposing edges of the acrylic sheet.

FIG. 5 is a portion of a cross-sectional view of an alternative embodiment taken at section A-A of FIG. 1, showing a top-emitting, surface-mounted, and circuit-board-attached LED 1210 aimed into opposing edges of the acrylic sheet.

FIG. 6 is a portion of a cross-sectional view of an alternative embodiment taken at section A-A of FIG. 1, showing a side-emitting, surface-mounted, and circuit-board-attached LED 1210 aimed into opposing edges of the acrylic sheet.

FIG. 7 is a portion of a cross-sectional view of an alternative embodiment taken at section A-A of FIG. 1, showing a generic light source 1210, such as a florescent tube backed by reflective material 1290, aimed into opposing edges of the acrylic sheet.

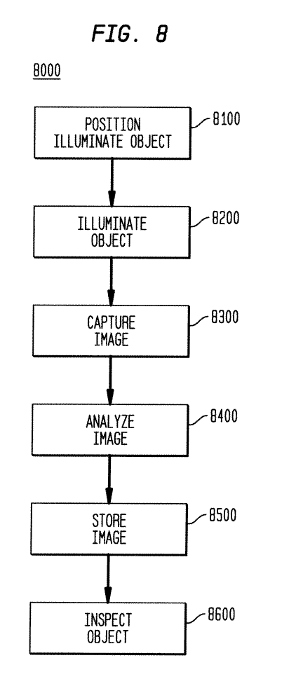

FIG. 8 is a flowchart of an exemplary embodiment of a method 8000. At activity 8100, an illumination system can be positioned with respect to an object to be illuminated. The illumination system can comprise a first sheet formed of a light-diffusing material, said first sheet defining a pair of opposing faces and two pairs of opposing edges, said first sheet adapted to provide a substantially uniform illumination from at least one of said faces when light is transmitted into any of said edges; a first reflective layer adapted to reflect light toward a second face of said pair of faces; a second sheet formed of a light diffusing material; and a first light source adapted to transmit light into a first edge of said edges.

At activity 8200, the object can be illuminated via the illumination system. The illumination can provide lighting from one or more predetermined angles. The illumination can provide back-lighting, front-lighting, side-lighting, etc.

At activity 8300, an image of the illuminated object can be captured by a camera and/or machine vision system. At activity 8400, the image can be analyzed and/or interpreted by the camera and/or machine vision system. At activity 8500, the image can be stored. At activity 8600, the object can be inspected.

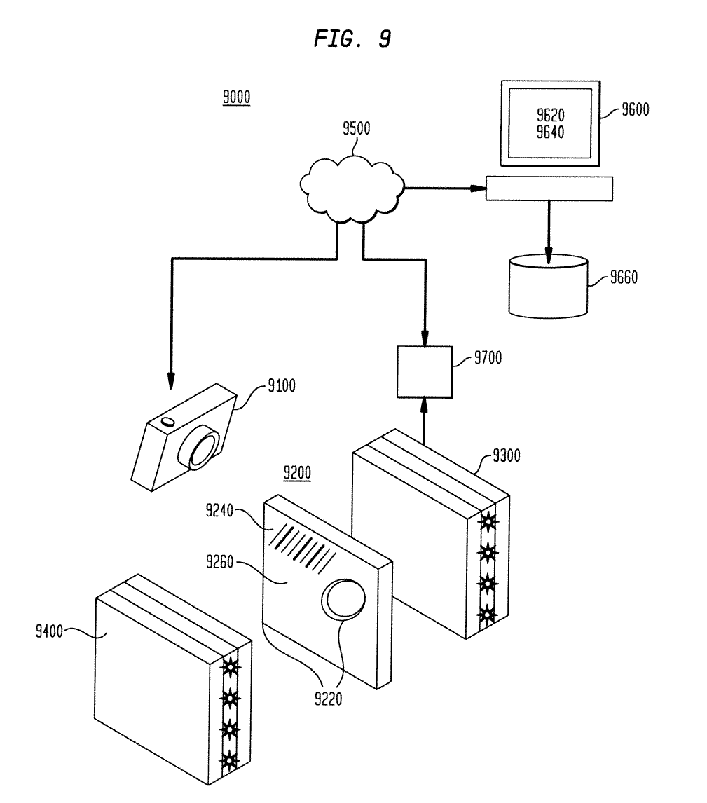

FIG. 9 is a block diagram of an exemplary embodiment of a system 9000, showing a machine vision camera and/or machine vision system 9100 that is adapted to capture and/or interpret an image of an object 9200, which can be illuminated by an illumination system, such as backlight system 9300 that can help illuminate an edge 9220 of object 9200, and/or frontlight and/or sidelight system 9400 that can help illuminate a bar code 9240 on an exposed surface 9260 of object 9200. Camera 9100 can be coupled via a network 9500 to a machine vision information device 9600 which can comprise a user interface 9620, a user program 9640, and/or a memory device 9660. User program 9640 can be adapted to process image information received from camera and/or Machine Vision system 9100. User interface 9620 can be adapted to render information regarding user program 9640 and/or image information obtained from camera and/or Machine Vision system 9100. Memory device 9660 can be adapted to store image information and/or information related to controlling illumination systems, such as backlight system 9300 and/or frontlight and/or sidelight system 9400.

A light controller 9700, which can comprise a processor, can control each illumination system, such as backlight system 9300 and/or frontlight and/or sidelight system 9400. Light controller 9700 can be adapted to turn on, turn off, and/or vary the intensity and/or duration of any light source and/or subset of light sources in each illumination system.

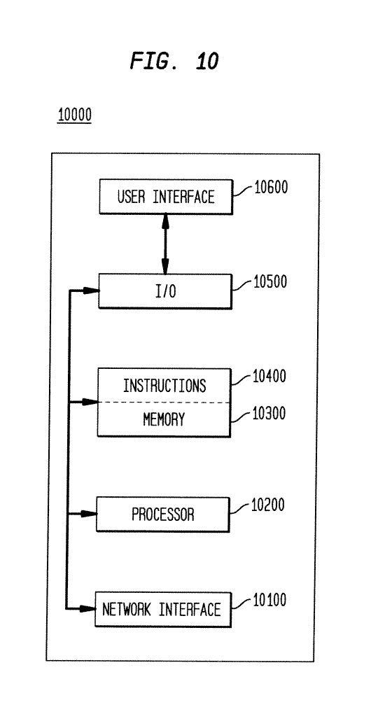

FIG. 10 is a block diagram of an exemplary embodiment of an information device 10000, which in certain operative embodiments can comprise, for example, machine vision system 9100, machine vision information device 9600, and/or lighting controller 9700 of FIG. 9. Information device 10000 can comprise any of numerous components, such as for example, one or more network interfaces 10100, one or more processors 10200, one or more memories 10300 containing instructions 10400, one or more input/output (I/O) devices 10500, and/or one or more user interfaces 10600 coupled to I/O device 10500, etc.

In certain exemplary embodiments, via one or more user interfaces 10600, such as a graphical user interface, a user can view a rendering of information related to researching, designing, modeling, creating, developing, building, manufacturing, operating, controlling, maintaining, storing, marketing, selling, delivering, selecting, specifying, requesting, ordering, receiving, returning, rating, and/or recommending any of the systems, products, services, methods, and/or information described herein.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
adapted—made suitable or fit for a specific use or situation.
and/or—either in conjunction with or in alternative to.
backlight—a light source placed behind an object to create contrast that separates the object from the background.
barcode—information expressible as a series of symbols, such as clusters of dots, parallel bars of varying widths, etc., that can be read by an optical scanner and interpreted as numerical and/or alphabetical characters.
barcode reader—a device and/or system adapted to scan and/or decode a barcode.
can—is capable of, in at least some embodiments.
data matrix—an arrayed pattern that can be directly marked on parts by altering their surface appearance using dot peen, laser etch, and other means.
diffusing—characterized by spreading and/or scattering.
direct part marking (DPM)—a technology whereby an item is physically altered by methods such as dot peening, laser etching, molding, and/or embossing to provide a decodable symbol onto a surface of the item.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
light—electromagnetic radiation of any wavelength, including wavelengths such as microwave, infrared, visible, ultra-violet, x-rays, and/or gamma-rays, etc.
light controller—a controller that is adapted to cause an illumination of one or more light sources.
light emitting diode (LED)—a semiconductor device that emits (typically visible) light responsive to an applied electrical conducting current.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
machine vision—a device and/or vehicle adapted to perform at least one task.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
plurality—the state of being plural and/or more than one.
polymeric—formed from any of numerous natural and synthetic compounds of usually high molecular weight consisting of up to millions of repeated linked units, each a relatively light and simple molecule.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
substantially—to a considerable, large, and/or great, but not necessarily whole and/or entire, extent and/or degree.
surround—to encircle, enclose, and or confine on several and/or all sides.
system—a collection of mechanisms, devices, machines, articles of manufacture, processes, data, and/or instructions, the collection designed to perform one or more specific functions.
unfaceted—generally lacking multiple non-perpendicular and non-parallel planar surfaces.
ungrooved—generally lacking one or more long, narrow cuts, channels, and/or or indentations in a surface.
uniform—substantially even, consistent, constant, and/or without variation.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A system comprising:
a substantially planar first sheet formed of a substantially transparent, unfaceted, ungrooved, light-diffusing polymeric material, said first sheet defining a pair of opposing substantially planar faces and two pairs of opposing substantially planar edges, each of said edges perpendicular to each of said faces, said first sheet adapted to provide a substantially uniform illumination from at least one of said faces when light is transmitted into any of said edges;
a substantially planar first reflective layer located substantially parallel to a first face of said pair of faces and adapted to reflect light toward a second face of said pair of faces;
a substantially planar second sheet formed of a substantially light diffusing material, said second sheet located substantially parallel to said second face, said second sheet separated from said first sheet by a first predetermined gap; and
a first light source located substantially adjacent to, and adapted to transmit light into, a first edge of said edges.

2. The system of claim 1, further comprising:
a substantially planar base located substantially parallel to said first sheet, said base separated from said first sheet by a second predetermined gap.

3. The system of claim 1, further comprising:
a substantially planar base located substantially parallel to said first sheet, said base separated from said first sheet by a second predetermined gap, said base comprising said first reflective layer.

4. The system of claim 1, further comprising:
a substantially planar base located substantially parallel to said first sheet, said base separated from said first sheet by a second predetermined gap, said base comprising a heat sink adapted to dissipate heat generated by said first light source.

5. The system of claim 1, further comprising:
a substantially planar base located substantially parallel to said first sheet, said base separated from said first sheet by a second predetermined gap, said first light source attached to said base.

6. The system of claim 1, further comprising:
a substantially planar base located substantially parallel to said first sheet, said base separated from said first sheet by a second predetermined gap, said base comprising a cavity adapted to attachably receive said first light source.

7. The system of claim 1, further comprising:
a substantially planar second reflective layer located substantially parallel to a second edge of said edges and adapted to reflect light into said first sheet.

8. The system of claim 1, wherein:
said first edge is polished.

9. The system of claim 1, wherein:
said first sheet comprises at least one cavity adapted to at least partially surround said first light source.

10. The system of claim 1, wherein:
said first light source comprises at least one light emitting diode.

11. The system of claim 1, wherein:
said first light source comprises an array of light emitting diodes.

12. The system of claim 1, further comprising:
a second light source located substantially adjacent to, and adapted to transmit light into, a third edge of said edges that opposes said first edge.

13. The system of claim 1, further comprising:
a substantially planar cover located substantially adjacent to, and adapted to block undesired illumination from said system.

14. The system of claim 1, further comprising:
a machine vision camera aimed substantially toward, and adapted to capture an image of an object backlit by, said second face.

15. The system of claim 1, further comprising:
a machine vision camera aimed substantially away from, and adapted to capture an image of an object frontlit by, said second face.

16. The system of claim 1, further comprising:
a machine vision system adapted to capture an image of an object illuminated by said second face.

17. A system comprising:
a substantially planar first sheet formed of a substantially transparent, unfaceted, ungrooved, light-diffusing polymeric material, said first sheet defining a pair of opposing substantially planar faces and two pairs of opposing substantially planar edges, each of said edges perpendicular to each of said faces, said first sheet adapted to provide a substantially uniform illumination from at least one of said faces when light is transmitted into any of said edges;
a substantially planar second sheet formed of a substantially light diffusing material, said second sheet located substantially parallel to said second face, said second sheet separated from said first sheet by a first predetermined gap,
a substantially planar cover located substantially adjacent to, and adapted to block undesired illumination from said system;
a first light source located substantially adjacent to, and adapted to transmit light into, a first edge of said edges; and
a substantially planar base located substantially parallel to said first sheet, said base separated from said first sheet by a second predetermined gap, said first light source adapted to be attached to said base, said base comprising:
a heat sink adapted to dissipate heat generated by said first light source; and
a substantially planar first reflective layer applied to a substantially planar face of said heat sink, located substantially parallel to a first face of said pair of faces, and adapted to reflect light toward a second face of said pair of faces.

18. A method, comprising:
capturing an image of an object illuminated by a system comprising:
a substantially planar first sheet formed of a substantially transparent, unfaceted, ungrooved, light-diffusing polymeric material, said first sheet defining a pair of opposing substantially planar faces and two pairs of opposing substantially planar edges, each of said edges perpendicular to each of said faces, said first sheet adapted to provide a substantially uniform illumination from at least one of said faces when light is transmitted into any of said edges;
a substantially planar second sheet formed of a substantially light diffusing material, said second sheet located substantially parallel to said second face, said second sheet separated from said first sheet by a first predetermined gap;
a substantially planar cover located substantially adjacent to, and adapted to block undesired illumination from said system;
a first light source located substantially adjacent to, and adapted to transmit light into, a first edge of said edges; and
a substantially planar base located substantially parallel to said first sheet, said base separated from said first sheet by a second predetermined gap, said first light source adapted to be attached to said base, said base comprising:
a heat sink adapted to dissipate heat generated by said first light source; and
a substantially planar first reflective layer applied to a substantially planar face of said heat sink, located substantially parallel to a first face of said pair of faces, and adapted to reflect light toward a second face of said pair of faces.

19. The method of claim 18, further comprising:
backlighting said object via said system.

20. The method of claim 18, further comprising:
frontlighting said object via said system.

21. The method of claim 18 further comprising:
sidelighting said object via said system.
